(19) United States
(12) Patent Application Publication
(10) Pub. No.: US 2022/0412113 A1
(43) Pub. Date: Dec. 29, 2022

(54) Swimming Pool Chemical Dispenser

(71) Applicant: Ningbo Bonny E-Home Co., Ltd., Ningbo (CN)

(72) Inventor: Hongchuan ZHANG, Ningbo (CN)

(21) Appl. No.: 17/877,850

(22) Filed: Jul. 29, 2022

Related U.S. Application Data
(63) Continuation of application No. 16/862,573, filed on Apr. 30, 2020.

(51) Int. Cl. E04H 4/12; G01K 1/14; C02F 1/68

(52) U.S. Cl. CPC E04H 4/1281; G01K 1/14; C02F 1/687; C02F 2103/42

(57) ABSTRACT

A swimming pool chemical dispenser includes a main body having an accommodating cavity formed therein for storing chemical tablets, an upper cover which covers the upper opening of the main body, and a tablet clamp having a clamping end penetrating downward through the upper cover and abutting against the chemical tablets. The tablet clamp is provided with scales. The tablet clamp descends along with the dissolution of the chemical tablets and the amount of residual chemical tablets can be visually and reliably determined from the scales on the tablet clamp for timely refill. The tablet clamp is placed on the main body, thus making it convenient for the user to replace the chemical tablets bare-handed without touching the chemical tablets, which is much safer and more environmentally friendly.

### CROSS REFERENCE OF RELATED APPLICATION

This application is a continuation application that claims the benefit of priority under 35 U.S.C. § 120 to a non-provisional application, application Ser. No. 16,862,573, filed Apr. 30, 2020, which is incorporated herewith by reference in its entirety.

### BACKGROUND OF THE PRESENT INVENTION

### Field of Invention

The present invention relates to swimming pool auxiliary tools, and more particularly to a swimming pool chemical dispenser which comprises an indicator clamp that not only provides an indication of the residual amount of chemical tablet but also allows the user to pick up and place chemical tablets in the dispenser.

### Description of Related Arts

A swimming pool chemical dispenser is a product used in swimming pools to purify water in the pool. Normally, it comprises a barrel with a float inside, and the inner part of the barrel is provided with an accommodating cavity to store chemical tablets. Due to the structure of the conventional product, a user needs to remove and place the chemical tablets in the accommodating cavity with bare hand or with gloved hand when replacing and refilling, and the irritating odor of the chemical tablets may also potentially harm the skin and the health of the user. Meanwhile, during usage, the residual quantity of the chemical tablets in the barrel cannot be visually observed and the user has to open the upper cover of the barrel from time to time for timely replacement or refill which makes it extremely inconvenient.

### SUMMARY OF THE PRESENT INVENTION

The invention is advantageous in overcoming the shortcomings of the prior arts by providing a swimming pool chemical dispenser, with which it is visual and reliable to determine the remaining amount of the chemical tablets to facilitate the timely refill of the chemical tablets without including any extra component.

Another advantage of the invention is to provide a tablet clamp for a swimming pool chemical dispenser which is configured to be slidably retained in the swimming pool chemical dispenser for ease to reach and use by the user to pick and place chemical tablets in the accommodating cavity of the swimming pool chemical dispenser while the tablet clamp is also an indicator incorporated with the remaining chemical tablets in the accommodating cavity to indicate the remaining amount of the chemical tablets in the accommodating cavity.

Another advantage of the invention is to provide a swimming pool chemical dispenser which comprises a tablet clamp configured to have a clamping end thereof abutting on an uppermost chemical tablet in the accommodating cavity thereof due to gravity and to intervally provide indicator scales around an elongated shaft of the tablet clamp and supported outside the swimming pool chemical dispenser for indicating the amount of the remaining chemical tablets in the accommodating cavity for visual observation by the user.

Another advantage of the invention is to provide a swimming pool chemical dispenser which upper cover provides a pair of guiding slots configured to allow two clamping arms of the tablet clamp fittingly and smoothly sliding therethrough to retain the tablet clamp in an upright position coaxially, such that the tablet clamp is downwardly extended due to gravity until its clamping end resting on top of the uppermost chemical tablets stacked overlappedly in the accommodating cavity and the upper shaft of the tablet clamp, which has the scales provided intervally, upwardly extended out of the inner cover for visual obstervation.

Another advantage of the invention is to provide a swimming pool chemical dispenser which does not incorporate expensive or complicate components but simply provides a tablet clamp in a specific configuration that not only stores the tablet clamp in a handy and easy reachable manner but also can be functioned as an indicator to indicate the remaining amount of chemical tablets stored therein.

According to the present invention, the foregoing and other objects and advantages are attained by a swimming pool chemical dispenser for storing a plurality of chemical tablets, comprising:

a main body having an upper opening, at least one lower opening, an accommodating cavity formed therein and axially extended from the upper opening to a bottom thereof for storing the plurality of chemical tablets and communicating outside via the at least one lower opening, and at least one upper chamber provided around the accommodating cavity;

at least one float contained in the at least one upper chamber of the main body for enabling the main body floating on a water of a swimming pool, while a lower portion of the main body positioned in the water of the swimming pool allowing the water entering the accommodating cavity through the at least one lower opening, and an upper portion of the main body positioned above the water of the swimming pool;

an upper cover covering the upper opening of the main body and having a channel formed by one or more guiding slots therethrough;

a tablet clamp comprising an upper member, a clamping end configured for clamping at least one chemical tablet at one time, and an elongated shaft extended between the upper member and the clamping end, wherein a predetermined number of scales are intervally and transversely formed along the shaft, wherein the clamping end of the tablet clamp is downwardly and axially extended to fittingly and smoothly penetrating through the at least one guiding slot of the channel into the accommodating cavity until abutting on an uppermost chemical tablet of the plurality of chemical tablets due to gravity, while the shaft is retained in an upright manner by the upper cover and upwardly extended out of the upper cover, and one or more of the predetermined number of scales is displayed above the water of the swimming pool, wherein the tablet clamp descends along with a dissolution of at least a lowermost chemical tablet of the plurality of chemical tablets, such that the user is able to determine an amount of the chemical tablets remained in the accommodating cavity according to a number of the predetermined number of scales observed above the upper cover.

In one embodiment, the main body comprises a shell which comprises a barrel and an outer housing sleeved outside the barrel and the upper chamber is a region for mounting the float between the barrel and the outer housing.

In one embodiment, the barrel has an inner wall defining the accommodating cavity extended from a top end thereof to a bottom end thereof, wherein the upper opening is coaxially formed at the top end and the lower opening is transversely formed at a bottom portion of the inner wall. The outer housing has an outer wall surrounding an upper portion of the barrel to define the upper chamber between the outer wall of the outer housing and the inner wall of the barrel so as to contain the float therein. Wherein the accommodating cavity is sized adapted for receiving the plurality of chemical tablets overlapped therein.

In one embodiment, the plurality of scales is formed by indicating grooves indented around the shaft of the tablet clamp, such that the amount of residual chemical tablets can be visually and reliably determined from the scales on the tablet clamp for timely refill of the chemical tablets.

In one embodiment, the clamping end of the table clamp comprises a pair of resilient clamping arms having a distance slightly larger than a thickness of a chemical tablet defined therebetween, wherein the plurality of scales is formed around the shaft intervally that a distance between each two adjacent scales of the plurality of scales is generally equal to the thickness of the chemical tablet.

In one embodiment, the upper cover comprises a ring shape outer cover configured to cover the upper chamber between an outer wall of the outer housing and an inner wall of the barrel, and an inner cover arranged to cover the opening of the barrel, wherein the channel for the tablet clamp to pass through is formed in the inner cover in a penetrating mode.

In one embodiment, an inner circle wall of the outer cover inwardly protruded to form an annular step surface such that a lower end of an outer edge of the inner cover is placed on the annular step surface.

In one embodiment, a side wall of the shell is provided with at least one transparent window for direct observation of the residual chemical tablets stored in the accommodating cavity.

In one embodiment, the side wall of the shell is further provided with a thermometer for detecting a temperature of the pool water.

In one embodiment, the number of the transparent windows is two, and the thermometer is embedded within one of the two transparent windows.

In one embodiment, a bottom cover is screwed at a bottom of the shell, and peripheral walls of the bottom cover and a bottom of the shell are respectively provided with grid structures, wherein the grid structure provided in the bottom end of the shells forms the lower opening of the main body.

In one embodiment, one side of the outer housing is provided with a ring structure.

In accordance with another aspect of the invention, the present invention provides a method of indicating residual chemical tablets in a swimming pool chemical dispenser, comprising:

providing a tablet clamp which comprises an upper member, a clamping end configured for clamping at least one chemical tablet at one time, and an elongated shaft extended between the upper member and the clamping end, wherein the clamping end comprises a pair of resilient clamping arms having a distance slightly larger than a thickness of a chemical tablet defined therebetween, and that a plurality of scales is formed around the shaft intervally, wherein a distance between each two adjacent scales of the plurality of scales is generally equal to the thickness of the chemical tablet to be stored in an accommodating cavity formed in a main body;

retaining the tablet clamp in an upright manner by an upper cover covering an upper opening of the accommodating cavity of the main body in such a manner that the clamping end of the tablet clamp is extended downwardly through a channel of the upper cover until abutting on an uppermost chemical tablet of a plurality of chemical tablets overlappedly stacked in the accommodating cavity due to gravity while at least a portion of the shaft is extended upwardly out of the upper cover;

allowing the tablet clamp descending along with a dissolution of a lowermost chemical tablet of the plurality of chemical tablets remained in the accommodating cavity while the shaft of the tablet clamp fittingly and smoothly penetrates the channel;

indicating an amount of the chemical tablets remained in the accommodating cavity according to a number of the scales exposed above the upper cover; and

clamping one chemical tablet between the pair of clamping arms by pressing the pair of clamping arms towards each other against two sides of the chemical tablet respectively for placing the chemical tablet into the accommodating cavity through the upper opening with the upper cover removed while the tablet clamp is detached from the upper cover by sliding out through the channel of the upper cover.

The technical scheme has the beneficial effects that:

(1) The swimming pool chemical dispenser comprises the main body, the upper cover and the tablet clamp which is provided with the plurality of scales, so that the amount of residual chemical tablets can be visually and reliably determined from the scales on the tablet clamp for timely refill, wherein the tablet clamp is normally placed on the main body thus making it convenient for the user to replace the tablets bare-handed without touching the tablets.

(2) The arrangement of the transparent window facilitates direct observation of the amount of chemical tablets remaining within the dispenser.

(3) The arrangement of the thermometer facilitates testing and observing the water temperature.

(4) The peripheral walls of the bottom cover an the bottom shell are respectively provided with grid structures, thus the water inflow can be adjusted by the rotation of the bottom cover, and the effect of adjusting the release speed of the tablets is achieved.

(5) The arrangement of the tablet clamp configured for clamping chemical tablet for refilling not only not only retains by the main body while penetrating through the channel normally, but also indicates the amount of the residual chemical tablets stored in the accommodating cavity through the number of scales provided on the tablet clamp being extended out of the main body.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a swimming pool chemical dispenser according to a preferred embodiment of the present invention.

FIG. 2 is a sectional view of the swimming pool chemical dispenser according to the above preferred embodiment of the present invention.

FIG. 3 is an exploded view of the swimming pool chemical dispenser according to the above preferred embodiment of the present invention.

FIG. 4 is an exploded view of the shell and the lower cover of the swimming pool chemical dispenser according to the preferred embodiment of the present invention.

FIG. 5 is a perspective view of the tablet clamp of the swimming pool chemical dispenser according to the preferred embodiment of the present invention.

The drawings, described above, are provided for purposes of illustration, and not of limitation, of the aspects and features of various examples of embodiments of the invention described herein. The drawings are not intended to limit the scope of the claimed invention in any aspect. For simplicity and clarity of illustration, elements shown in the drawings have not necessarily been drawn to scale and the dimensions of some of the elements may be exaggerated relative to other elements for clarity.

### DETAILED DESCRIPTION OF THE PREFERRED EMBODIMENT

The following description is disclosed to enable any person skilled in the art to make and use the present invention. Preferred embodiment is provided in the following description only as example and modifications will be apparent to those skilled in the art. The general principles defined in the following description would be applied to other embodiments, alternatives, modifications, equivalents, and applications without departing from the spirit and scope of the present invention.

It will be appreciated that numerous specific details are set forth in order to provide a thorough understanding of the exemplary embodiment described herein. However, it will be understood by those of ordinary skill in the art that the embodiment described herein may be practiced without these specific details. In other instances, well-known methods, procedures and components have not been described in detail so as not to obscure the embodiment described herein. Further, this description is not to be considered as limiting the scope of the embodiments described herein in any way, but rather as merely describing implementation of the one or more embodiments described herein.

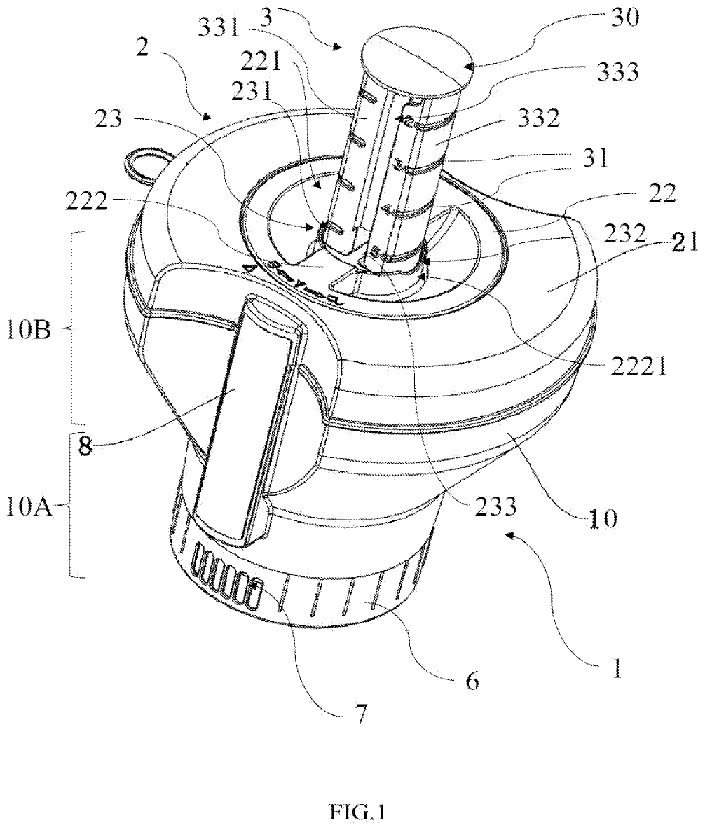

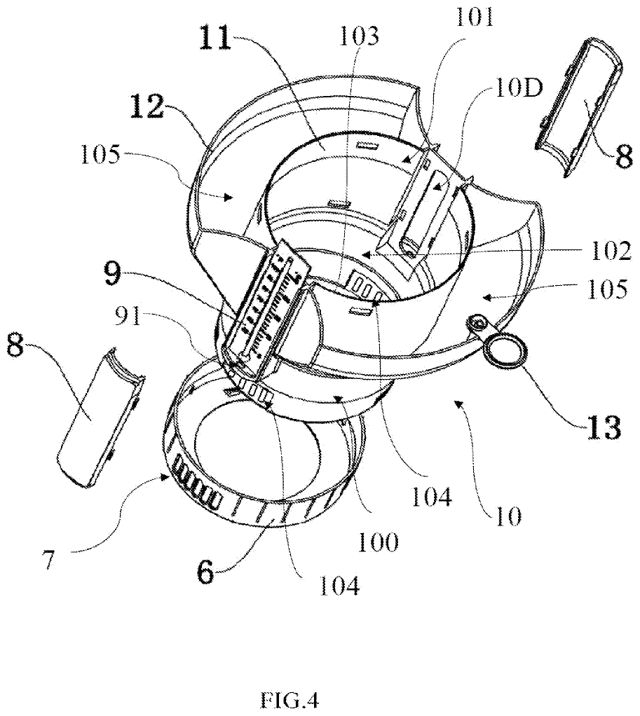

Referring to FIGS. 1-5, a swimming pool chemical dispenser according to a preferred embodiment of the present invention is illustrated. The swimming pool chemical dispenser comprises a main body 1, an upper cover 2, a tablet clamp 3, and at least one float 4. The main body 1 has an upper opening 101, a bottom 103 having at least one lower opening 104 transversely formed, an accommodating cavity 102 formed therein and axially extended from the upper opening 101 to the bottom 103 thereof for storing a plurality of chemical tablets 5 therein overlappedly and communicating outside via the at least one lower opening 104, and at least one upper chamber 105 provided at an upper portion thereof. The upper cover 2 is configured to cover the upper opening 101 of the main body 1 and has a channel 23 formed therethrough.

The at least one float 4 is accommodated in the at least one upper chamber 105 to provide a surrounding floating ability around the main body 1 such that when the main body is placed in water, a lower portion of the main body is immersed in the water and the upper portion of the main body floats above the water due to the floatage of the at least one float 4.

The tablet clamp 3 has a predetermined number scales 31 intervally provided around and a clamping end 32 penetrating downwardly through the upper cover 2 and abutting against an uppermost chemical tablets 5A of the plurality of chemical tablets 5, such that the tablet clamp 3 descends along with the dissolution of the plurality of chemical tablets 5 and displays the amount of residual chemical tablets 5 in the main body 1.

In other words, the amount of residual chemical tablets 5 can be visually and reliably determined from the scales 31 intervally provided on the tablet clamp 3 for timely refill of the chemical tablets 5, wherein the tablet clamp 3 placed on the main body 1 makes it convenient for the user to replace or refill the chemical tablets 5 bare-handed without touching the chemical tablets 5.

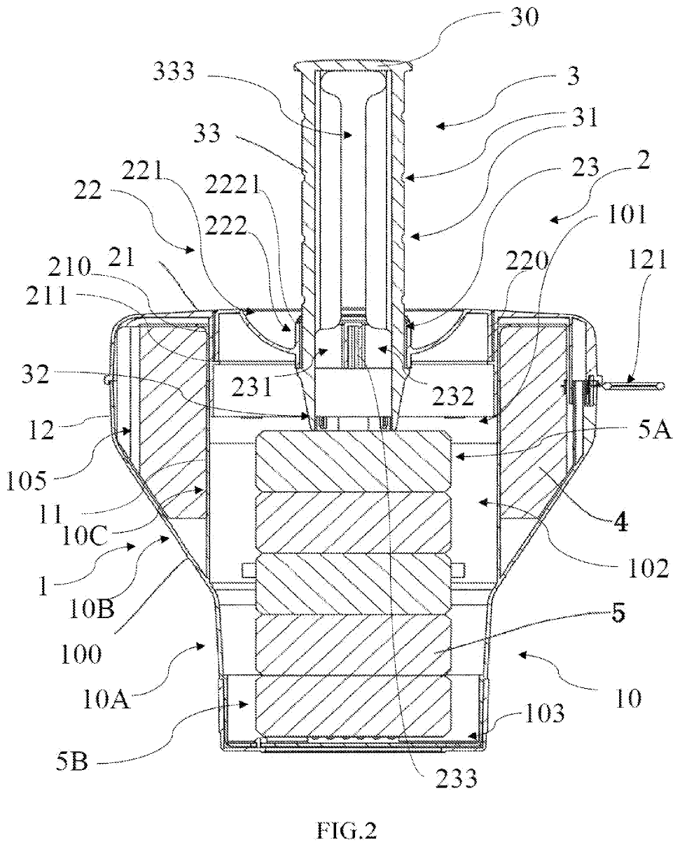

According to the preferred embodiment, specifically as shown in FIGS. 2-44, the main body 1 comprises a shell 10 having the upper opening 101 at an upper end thereof and at least a lower opening 104 communicating the accommodating cavity 102 with outside, wherein the accommodating cavity 102 is formed axially in the shell 10, extending from the upper opening 101 to the bottom 103. Each of the plurality of chemical tablets 5 to be accommodated in the accommodating cavity 102 has predetermined diameter and thickness. The accommodating cavity 102 is preferred to be a circular space having a diameter slightly larger than the diameter of the chemical tablet 5 and a predetermined depth adapted for stacking and storing the plurality of chemical tablets 5 therein overlappedly.

Referring to FIG. 2, the shell 10 has a circular side wall 100 upwardly extended from the bottom 103 defining a circular lower portion 10A and then upwardly and outwardly extended defining a circular upper potion 10B, and an inner wall 10C extended from a top end of the lower portion 10A upwardly which upper end defines the upper opening 101. The shell 10 comprises a barrel 11 defined by the inner wall 10C and the lower portion of the side wall 100 while the accommodating cavity 102 is defined by the barrel 11, an outer housing 12 defined by the upper portion 10B and positioned to be sleeved outside the barrel 11 to define the at least one upper chamber 105 between the upper portion of the side wall 10B and the inner wall 10C, wherein is region for mounting the at least one float 4 in position. Each of the at least one float 4 is made of floatage material and shaped to be fittingly and respectively contained in the at least one upper chamber 105 formed between the barrel 11 and the outer housing 12, such that the main body 1 being floating on a water of a swimming pool while the lower portion 10A immersed in the water of the swimming pool and the upper portion 10B floated above the water of the swimming pool, so that the pool water is able to flowing into the accommodating cavity 102 through the at least one lower opening 104 to dissolute at least a lowermost chemical tablet 5B of the plurality of chemical tablets 5 stored in the accommodating cavity 102.

As shown in FIGS. 2-4, both the barrel 11 and the outer housing 12 are preferred to be in circular shape coaxially, so that when the plurality of chemical tablets 5 are stacked and stored in the accommodating cavity 102, the weight of the entire main body 1 is concentric to ensure the main body 1 floating on pool water steadily and a pair of the lower opening 104 (embodied as grid structure 7) is provided at two opposing sides of a bottom end of the side wall 100 of shell 10 of the main body 1 to facilitate inflowing pool water therethrough contacting the lowermost chemical tablet 5B to dissolute the chemical such as water purifying chemical in the pool water and flowing out to the swimming pool. Also, the at least one upper chamber 105 is preferred to position surrounding the barrel 11 coaxially so that the main body 1 has the gradually larger upper portion 10B formed above the smaller lower portion 10A, so as to provide an even and steady floatage force to ensure the upper portion 10B of the main body 1 floating on water in a steady and balance manner.

According to the preferred embodiment, as shown in FIGS. 2-4, there are two opposing upper chambers 105 symmetrically formed between the two windows 8, and a pair of floats 4 is shaped and sized to fittingly accommodate in the two upper chambers 105 respectively, wherein such arrangement facilitates the main body 1 to float on water in a balance and upright manner ensuring the two windows 8 exposed and the tablet clamp 3 stood upright for ease of observation.

According to the preferred embodiment of the present invention, the side wall 100 of the shell 10 is provided with at least one transparent window 8 for direct observation of the amount of the residual chemical tablets 5. Further, the side wall 100 of the shell 10 is further provided with a thermometer 9 for detecting the temperature of the water. Further, the number of the transparent windows 8 is two, wherein one of the transparent windows 8 is provided for observing the accommodating cavity 102 and the chemical tablets 5 therein and another one of the transparent windows 8 is embedded with the thermometer 9 therein. Apparently, one side of the side wall 100 of the shell 10, the side of which facing the transparent window 8, is provided with an observation hole 10D, and the bottom of the embedded thermometer 9 is provided with an opening hole 91 allowing the pool water to flow inside and contact the temperature measuring end of the thermometer 9 for detecting and determining the temperature of the water in the swimming pool.

According to the preferred embodiment, the main body 1 of the swimming pool chemical dispenser further comprises a bottom cover 6 rotatably coupled, such as screwed, at the bottom end of the shell 10 thereof, wherein a peripheral wall of the bottom cover 6 is provided with a pair of grid structures 7 at positions corresponding to the grid structures of the lower openings 104 in such a manner that by rotating the bottom cover to adjust the alignment of the grid structures 7 of the bottom cover 6 and the pair of the lower openings 104 of the shell 10 of said main body 1 is able to substantially adjust and control the water flowing speed. In other words, the water inflow in the accommodating cavity 102 through the lower openings 104 can be adjusted by the rotation of the bottom cover 6, and the effect of adjusting the release speed of the chemical tablets 5 is achieved.

The upper cover 2 comprises a ring shape outer cover 21 configured to cover an upper end of the shell 10 and an inner cover 22 configured to cover the accommodating cavity 102. According to the preferred embodiment, as shown in FIGS. 1-3, the upper cover 2 is a ring shape structure and has a central inner circle wall 210 downwardly extended to an upper end portion of the barrel 11 and defining the upper opening 101 at the upper end of the accommodating cavity 102, such that the outer cover 21 fittingly covers the pair of upper chambers 105 to enclose the pair of floats 4 therein. The inner cover 22 has a shaped and a size adapted to mount at the upper opening 101 to cover the accommodating cavity 102.

The upper cover 2 also functioned as a docking station and holster for the tablet clamp 3 normally. According to the preferred embodiment, the upper cover 2 has a channel 23 formed at a central position extending downwardly from outside to the accommodating cavity 102, which is configured for the tablet clamp 3 to coaxially pass through in a penetrating mode, wherein the clamping end 32 of the tablet clamp 3 penetrates downward through the channel 23 of the upper cover 2 until abutting against the uppermost chemical tablet 5A of the plurality of chemical tablets 5 stored in the accommodating cavity 102 due to gravity such that the tablet clamp 3 descends along with the dissolution of the chemical tablets 5.

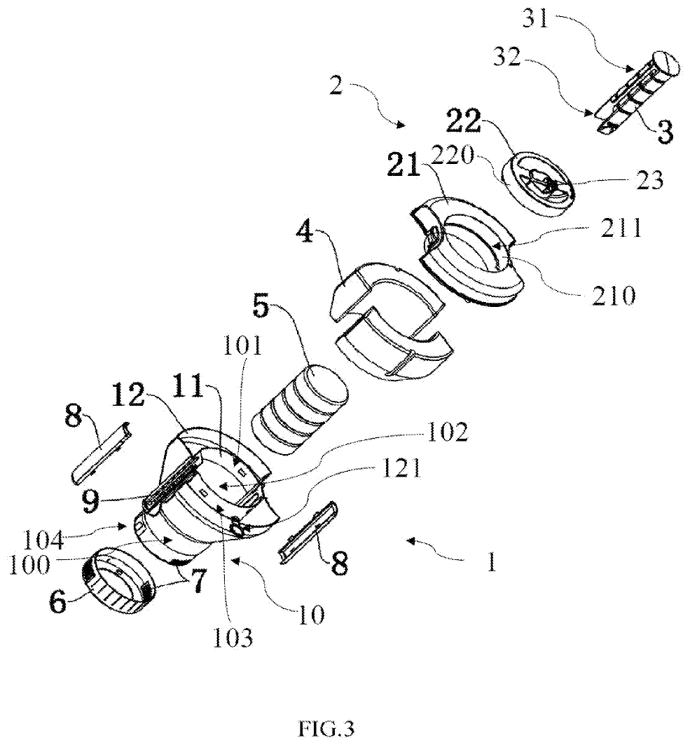

It is worth mentioning that the inner circle wall 210 of the outer cover 21 sinks inwardly and forms an annular step surface 211 functioned as a stopper such that a lower end of an outer edge of the inner cover 22 is able to be sat and placed on the annular step surface 211, as shown in FIG. 2 and FIG. 3. The user may selectively to open the upper opening 101 by removing the inner cover 22 or to remove the entire upper cover 2 including the outer cover 21 and the inner cover 22 at the same time for cleaning and etc. Further, one side of the outer housing 12 is provided with a ring structure 121, thus the swimming pool chemical dispenser can be removed from the swimming pool by means of a tool with a hook.

According to the preferred embodiment, as shown in FIGS. 2 and 3, the inner cover 22 has a circular side wall 220 shaped and sized to fittingly and sealedly mount at the inner circle wall 210 of the outer cover 21 to cover the upper opening 101 to enclose the accommodating cavity 102. In order to strengthen the inner cover 22 and facilitate the mounting and removal of the inner cover 22 with respect to the outer cover 21, as shown in FIGS. 1 and 2, the inner cover provides a concave groove 221 and a holder bar 222 extended across the concave groove 221 so that the user may simply hand grip the holder bar 222 to insert or pull out the inner cover 22 to access the accommodating cavity 102 for chemical tablet replacement or refilling.

The arrangement of the holder bar 222 also benefits the docking of the tablet clamp 3, wherein the channel 23 is formed at an enlarged central holster 2221 of the holder bar 222 of the inner cover 22 which has a predetermined length defining a relative depth of the channel 23 so as to hold on a predetermined portion of the tablet clamp 3 that substantially withholds the tablet clamp 3 extending in an upright manner coaxially.

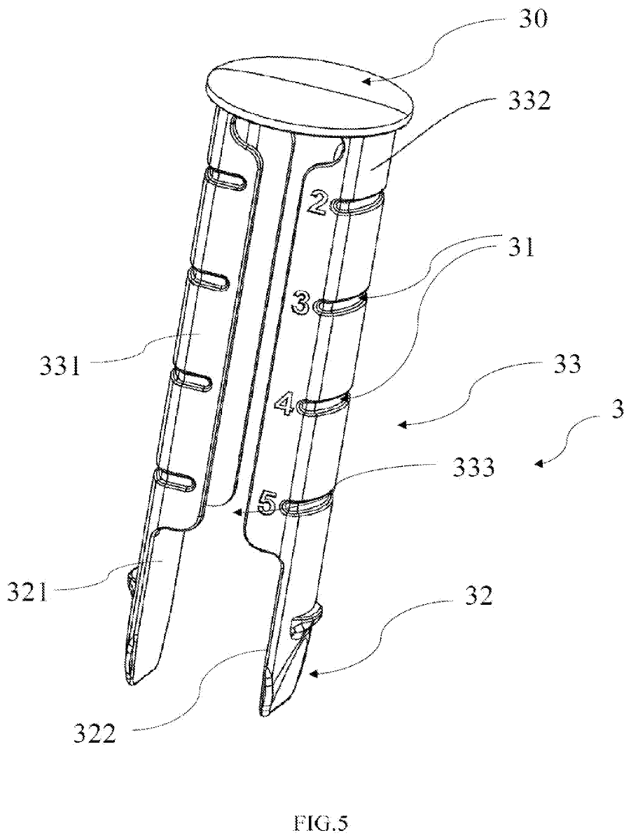

Referring to FIGS. 2 and 5, according to the preferred embodiment, the tablet clamp 3 comprises an upper member 30 and an elongated shaft 33 extended between the upper member 30 and the clamping end 32. The clamping end 32 is configured for clamping at least one chemical tablet at one time. The number of scales 31 equals to the total number of chemical tablets 5 adapted to be stored in the accommodating cavity 102. The predetermined number of scales 31 are intervally and transversely formed along the shaft 33, wherein the clamping end 32 is downwardly and axially extended to fittingly and smoothly penetrating through the channel 23 into the accommodating cavity until abutting on the uppermost chemical tablet 5A due to gravity while the shaft 33 is retained in the upright manner by the holster 2221 of the inner cover 22 of the upper cover 2 and the scales 32 are displayed above the water of the swimming pool, wherein the tablet clamp 3 descends along with the dissolution of the lowermost chemical tablet 5B of the plurality of chemical tablets 5, as shown in FIG. 2, such that the user is able to determine the amount of the chemical tablets 5 remained in the accommodating cavity 102 according to the number of the scales 32 observed above the upper cover 2.

According to the preferred embodiment, referring to FIG. 5, the clamping end 32 of the table clamp comprises a pair of resilient clamping arms 321, 322 having a distance slightly larger than a thickness of a chemical tablet 5 defined therebetween and each having a bottom edge adapted for resting and abutting against the uppermost chemical tablet 5A. To enhance the resilient ability of the clamping arms 321, 322, the shaft 33 comprises a pair shaft arms 331, 332 downwardly and integrally extended from the upper member 30 to the clamping arms 321, 322 respectively, such that the two shaft arms 331, 332 can be functioned as a handle for the user to hold and to press the two clamping arms 321, 322 towards each other to hold the chemical tablet 5 therebetween by compressing the two shaft arms 331, 332.

The tablet clamp 3 is able to not only be used for clamping the chemical tablet 5, but also to illustrate the number of chemical tablets 5 stored in the accommodating cavity 102 without incorporating extra components according to the present invention. Besides the tablet clamp 3 of the present invention is configured light in weight and rigid in structure, how to hold the tablet clamp 3 in upright position slidably and coaxially and avoid unwanted radial or sideward movement without complicated and expensive configuration is an essence objective of the present invention. To ensure the clamping end 32 of the tablet clamp 3 downwardly extends and remains resting on the uppermost chemical tablet 5A as well as to strengthen the configuration of the tablet clamp 3, each of the shaft arms 331, 332 has a U-shape cross section, and that a guiding shaft groove 333 is defined between the shaft arms 331, 332 of the shaft 33. Correspondingly, the channel 23 is formed by a pair of guiding slots 231, 232 in the inner cover 22 of the upper cover 2, as shown in FIGS. 1 and 2, wherein a separator 233 is formed between the two guiding slots 231, 232, and that the guiding slots 231, 232 are shaped and sized allowing the two shaft arms 331, 332 penetrating through respectively while the separator 233 is positioned in the guiding shaft groove 333. Accordingly, the tablet clamp 3 is able to be vertically held in the upright manner and guided to drop downward coaxially by above incorporation of the guiding slots 231, 232 and the separator 233 with the shaft arms 331, 332 and the guiding shaft groove 333. The plurality of scales 31 is formed by indicating grooves indented intervally and transversely on the shaft arms 331, 332 of the shaft 33 of the tablet clamp 3, such that the amount of residual chemical tablets 5 can be visually and reliably determined from the scales 31 on the tablet clamp 3 for timely refill of the chemical tablets 5.

In view of above, simply by the specific design and configuration of the tablet clamp 3 and the inner cover 22, the tablet clamp 3 is also functioned as indicator of the number of the residual chemical tablets 5 in the accommodating cavity 102 without any extra components. In a specific application, the inner cover 22 can be taken out from the outer cover 21 directly to expose the accommodating cavity 102, so that the chemical tablets 5 can be easily replaced.

In accordance with another aspect of the invention, the present invention provides a method of indicating residual chemical tablets in a swimming pool chemical dispenser by the tablet clamp 3, comprising:

(a) providing the tablet clamp 3 as described in the above preferred embodiment;

(b) retaining the tablet clamp 3 in an upright manner by the upper cover 2 covering the upper opening 101 of the accommodating cavity 102 of the main body 1 in such a manner that the clamping end 32 of the tablet clamp 3 is extended downwardly through the channel 23 of the upper cover 2 until abutting on the uppermost chemical tablet 5A of the plurality of chemical tablets 5 overlappedly stacked in the accommodating cavity 102 due to gravity while at least a portion of the shaft 33 is extended upwardly out of the upper cover 2;

(c) allowing the tablet clamp 3 descending along with the dissolution of the lowermost chemical tablet 5B of the plurality of chemical tablets 5 remained in the accommodating cavity 102 while the shaft 33 of the tablet clamp 3 fittingly and smoothly penetrates the channel 23;

(d) indicating an amount of the chemical tablets 5 remained in the accommodating cavity 102 according to the number of the scales 31 exposed above the upper cover 2; and

(e) clamping one chemical tablet 5 between the pair of clamping arms 321, 322 by pressing the pair of clamping arms 321, 322 towards each other against two sides of the chemical tablet 5 respectively for placing the chemical tablet 5 into the accommodating cavity 102 through the upper opening 102 with the upper cover 2 removed while the tablet clamp 3 is detached from the upper cover 2 by sliding out through the channel 23 of the upper cover 2.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A swimming pool chemical dispenser for storing a plurality of chemical tablets for dispensing in a water of a swimming pool, comprising:
a main body having an upper opening, at least one lower opening, an accommodating cavity formed therein for storing the plurality of chemical tablets, and at least one upper chamber provided around said accommodating cavity, wherein said accommodating cavity is axially extended from said upper opening to a bottom thereof and communicating outside via said at least one lower opening;
at least one float contained in said at least one upper chamber for enabling said main body floating on the water of the swimming pool, while a lower portion of said main body positioned in the water of the swimming pool allowing the water entering said accommodating cavity through said at least one lower opening, and an upper portion of said main body positioned above the water of the swimming pool;
an upper cover covering said upper opening of said main body and having a channel formed therethrough;
a tablet clamp comprising an upper member, a clamping end configured for clamping at least one chemical tablet at one time, and an elongated shaft extended between said upper member and said clamping end, wherein said shaft of said tablet clamp has scales intervally and transversely formed thereon, wherein said clamping end is downwardly and axially extended to fittingly and smoothly penetrating through said channel into said accommodating cavity until abutting on an uppermost chemical tablet of said plurality of chemical tablets stored in said accommodating cavity due to gravity, while said shaft is retained in an upright manner by said upper cover and upwardly extended out of said upper cover, and one or more of said scales is displayed above the water of the swimming pool, wherein said tablet clamp descends along with a dissolution of at least a lowermost of chemical tablet of said plurality of chemical tablets, such that an amount of the chemical tablets remained in said accommodating cavity by observing a number of said scales above said upper cover, and that when said tablet clamp is removed out from said upper cover, said tablet clamp is adapted to clamp the at least one chemical tablet at one time to place in said accommodating cavity.

2. The swimming pool chemical dispenser, as recited in claim 1, wherein said clamping end of said tablet clamp comprises a pair of resilient clamping arms having a distance, slightly larger than a thickness of each of the plurality of chemical tablets, defined therebetween, wherein said shaft comprises a pair of shaft arms downwardly extended from said upper member to said clamping arms respectively and defining a guiding shaft groove between said pair of shaft arms, such that said pair of shaft arms is capable of functioning as a handle to press said two clamping arms towards each other to hold the chemical tablet therebetween by compressing said pair of shaft arms.

3. The swimming pool chemical dispenser, as recited in claim 1, wherein said upper cover comprises an inner cover configured to cover said upper opening and enclose said accommodating cavity, wherein said channel is formed in a holster of said inner cover which has a predetermined length defining a relative depth of said channel so as to hold a predetermined portion of said shaft of said tablet clamp to withhold said table clamp extending in the upright manner coaxially.

4. The swimming pool chemical dispenser, as recited in claim 2, wherein said upper cover comprises an inner cover configured to cover said upper opening and enclose said accommodating cavity, wherein said channel is formed in a holster of said inner cover which has a predetermined length defining a relative depth of said channel so as to hold a predetermined portion of said shaft of said tablet clamp to withhold said table clamp extending in the upright manner coaxially.

5. The swimming pool chemical dispenser, as recited in claim 2, wherein said channel is formed by a pair of guiding slots shaped and sized to allow said two shaft arms penetrating through respectively, wherein a separator is formed between said pair of guiding slots, wherein said guiding slots are shaped and sized allowing said shaft arms penetrating through respectively while said separate is positioned in said guiding shaft groove, so as to retain said tablet clamp being vertically held in the upright manner and guided to drop downward coaxially to rest on the uppermost chemical tablet.

6. The swimming pool chemical dispenser, as recited in claim 4, wherein said channel of said inner cover is formed by a pair of guiding slots shaped and sized to allow said two shaft arms penetrating through respectively, wherein a separator is formed between said pair of guiding slots, wherein said guiding slots are shaped and sized allowing said shaft arms penetrating through respectively while said separate is positioned in said guiding shaft groove, so as to retain said tablet clamp being vertically held in the upright manner and guided to drop downward coaxially to rest on the uppermost chemical tablet.

7. The swimming pool chemical dispenser, as recited in claim 1, wherein a distance each two adjacent scales of said scales equals to the thickness of each of the plurality of chemical tablets, wherein said scales are formed by indicating grooves indented intervally and transversely on said shaft.

8. The swimming pool chemical dispenser, as recited in claim 2, wherein said scales are formed by indicating grooves indented intervally and transversely on said shaft arms of said shaft, and a distance each two adjacent scales of said scales equals to the thickness of each of the plurality of chemical tablets.

9. The swimming pool chemical dispenser, as recited in claim 6, wherein said scales are formed by indicating grooves indented intervally and transversely on said shaft arms of said shaft, and a distance each two adjacent scales of said scales equals to the thickness of each of the plurality of chemical tablets.

10. The swimming pool chemical dispenser, as recited in claim 3, wherein said inner cover provides a concave groove and a holder bar extended across said concave groove, wherein said holster is formed at a central position of said holder bar.

11. The swimming pool chemical dispenser, as recited in claim 4, wherein said inner cover provides a concave groove and a holder bar extended across said concave groove, wherein said holster is formed at a central position of said holder bar.

12. The swimming pool chemical dispenser, as recited in claim 6, wherein said inner cover provides a concave groove and a holder bar extended across said concave groove, wherein said holster is formed at a central position of said holder bar.

13. The swimming pool chemical dispenser, as recited in claim 9, wherein said inner cover provides a concave groove and a holder bar extended across said concave groove, wherein said holster is formed at a central position of said holder bar.

14. The swimming pool chemical dispenser, as recited in claim 1, further comprising a bottom cover which is configured to rotatably cover a bottom end of said main body and has at least one grid structure formed in a side wall thereof, wherein said at least one lower opening is formed in at least one side of said bottom end of said main body and has a grid structure, such that by rotating said bottom cover to adjust an alignment of said grid structure of said bottom cover and said at least one lower opening of said main body is capable of adjusting and controlling a release speed of the plurality of chemical tablets stored in said accommodating cavity.

15. The swimming pool chemical dispenser, as recited in claim 2, further comprising a bottom cover which is configured to rotatably cover a bottom end of said main body and has at least one grid structure formed in a side wall thereof, wherein said at least one lower opening is formed in at least one side of said bottom end of said main body and has a grid structure, such that by rotating said bottom cover to adjust an alignment of said grid structure of said bottom cover and said at least one lower opening of said main body is capable of adjusting and controlling a release speed of the plurality of chemical tablets stored in said accommodating cavity.

16. The swimming pool chemical dispenser, as recited in claim 4, further comprising a bottom cover which is configured to rotatably cover a bottom end of said main body and has at least one grid structure formed in a side wall thereof, wherein said at least one lower opening is formed in at least one side of said bottom end of said main body and has a grid structure, such that by rotating said bottom cover to adjust an alignment of said grid structure of said bottom cover and said at least one lower opening of said main body is capable of adjusting and controlling a release speed of the plurality of chemical tablets stored in said accommodating cavity.

17. The swimming pool chemical dispenser, as recited in claim 6, further comprising a bottom cover which is configured to rotatably cover a bottom end of said main body and has at least one grid structure formed in a side wall thereof, wherein said at least one lower opening is formed in at least one side of said bottom end of said main body and has a grid structure, such that by rotating said bottom cover to adjust an alignment of said grid structure of said bottom cover and said at least one lower opening of said main body is capable of adjusting and controlling a release speed of the plurality of chemical tablets stored in said accommodating cavity.

18. The swimming pool chemical dispenser, as recited in claim 12, further comprising a bottom cover which is configured to rotatably cover a bottom end of said main body and has at least one grid structure formed in a side wall thereof, wherein said at least one lower opening is formed in at least one side of said bottom end of said main body and has a grid structure, such that by rotating said bottom cover to adjust an alignment of said grid structure of said bottom cover and said at least one lower opening of said main body is capable of adjusting and controlling a release speed of the plurality of chemical tablets stored in said accommodating cavity.

19. A method of indicating residual chemical tablets in a swimming pool chemical dispenser, comprising:
providing a tablet clamp which comprises an upper member, a clamping end configured for clamping at least one chemical tablet at one time, and an elongated shaft extended between said upper member and said clamping end, wherein said clamping end comprises a pair of resilient clamping arms having a distance slightly larger than a thickness of a chemical tablet defined therebetween, and that a plurality of scales is formed around said shaft intervally, wherein a distance between each two adjacent scales of said plurality of scales is generally equal to a thickness of each of a plurality of chemical tablet to be stored in an accommodating cavity formed in a main body;
retaining said tablet clamp in an upright manner by an upper cover covering an upper opening of said accommodating cavity of said main body in such a manner that said clamping end of said tablet clamp is extended downwardly through a channel of said upper cover until abutting on an uppermost chemical tablet of the plurality of chemical tablets overlappedly stacked in said accommodating cavity due to gravity while at least a portion of said shaft is extended upwardly out of said upper cover;
allowing said tablet clamp descending along with a dissolution of a lowermost chemical tablet of the plurality of chemical tablets remained in said accommodating cavity while said shaft of said tablet clamp fittingly and smoothly penetrates said channel;
indicating an amount of the chemical tablets remained in said accommodating cavity according to a number of said scales exposed above said upper cover; and
clamping one chemical tablet between said pair of clamping arms by pressing said pair of clamping arms towards each other against two sides of the chemical tablet respectively for placing the chemical tablet into said accommodating cavity through said upper opening with said upper cover removed while said tablet clamp is detached from said upper cover by sliding out through said channel of said upper cover.

20. The method, as recited in claim 19, further comprising a step of adjusting a release speed of the plurality of chemical tablets stored in said accommodating cavity by rotating a bottom cover which rotatably cover a bottom end of said main body to adjust an alignment of at least one grid structure provided in said bottom cover with at least one lower opening provided in said bottom end of said main body.
